(19) United States
(12) Patent Application Publication
(10) Pub. No.: US 2022/0136756 A1
(43) Pub. Date: May 5, 2022

(54) REFRIGERATOR

(71) Applicant: LG Electronics Inc., Seoul (KR)

(72) Inventor: HyeonJong KIM, Seoul (KR)

(21) Appl. No.: 17/517,338

(22) Filed: Nov. 2, 2021

(30) Foreign Application Priority Data
Nov. 2, 2020 (KR) 10-2020-0144247

(51) Int. Cl. F25D 17/04; F25D 17/06

(52) U.S. Cl. CPC F25D 17/042; F25D 2317/068; F25D 2317/0415; F25D 17/06

(57) ABSTRACT

A refrigerator includes: a cabinet defining a storage space and a machine room that is partitioned from the storage space, the machine room including a compressor and a condenser, a blowing fan provided in the machine room, a guide member configured to guide air from an outside of the machine room into the machine room and discharge air from the machine room to the outside of the machine room, and a deodorizing module that is provided inside the guide member and that is configured to remove an odor from air passing through the guide member.

### CROSS-REFERENCE TO RELATED APPLICATIONS

The present application claims priority under 35 U.S.C. 119 and 35 U.S.C. 365 to Korean Patent Application No. 10-2020-0144247, filed on Nov. 2, 2020, which is hereby incorporated by reference in its entirety.

### BACKGROUND

The present disclosure relates to a refrigerator.

In general, refrigerators are home appliances for storing foods at a low temperature in a storage chamber that is covered by a door. The refrigerator is configured to keep stored food in an optimal state by cooling the inside of the storage space using cold air generated through heat exchange with a refrigerant circulating in a refrigeration cycle.

In a typical refrigerator, a machine room in which components such as a compressor and a condenser for driving a refrigeration cycle are disposed may be provided separately from the storage space. In the case of the machine room, an internal space is empty, and a plurality of flow passages for cooling air communicating with the outside of the refrigerator may be defined for cooling the components inside the machine room.

In the machine room, defrost water generated in the evaporator or the space in which the evaporator is disposed may be stored. As such, when air is introduced from the outside of the refrigerator so as to cool the components inside the machine room and is discharged back to the outside of the refrigerator through the defrost water, there is a problem in that an odor is generated.

### SUMMARY

Embodiments provide a refrigerator capable of removing an odor from air flowing in and out for cooling components provided in a machine room.

Embodiments provide a refrigerator capable of removing an odor from air by including a deodorizing module in a passage through which air flows for cooling components provided in a machine room.

A refrigerator according to one aspect of the present disclosure includes a cabinet defining a storage space and a machine room which is partitioned from the storage space and in which a compressor and a condenser are disposed, a blowing fan unit provided in the machine room, a guide member provided to allow air to be introduced into or discharged from the machine room, and a deodorizing module provided inside the guide member to remove an odor contained in the air passing through the guide member.

The guide member may have one side mounted to the cabinet and the other side mounted to the machine room.

The guide member may include a cabinet mounting portion mounted to the cabinet, a machine room mounting portion spaced apart from the cabinet mounting portion and mounted to a frame of the machine room, and a connection portion connecting the cabinet mounting portion to the machine room mounting portion and defining an accommodation portion in which the deodorizing module is accommodated.

The connection portion may define a passage through which air flows.

The deodorizing module may be formed in a size corresponding to a size of the accommodation portion.

The deodorizing module may include a deodorizing filter configured to remove an odor by adsorbing odorous substances contained in the air.

The deodorizing module may further include a module frame configured to support the deodorizing filter and define an outer shape of the deodorizing module.

The deodorizing module may further include a fixing portion protruding from the module frame so as to be fixed to the accommodation portion.

The blowing fan unit may be provided between the compressor and the condenser, so that the machine room is divided into a suction portion in which the condenser is disposed and a discharge portion in which the compressor is disposed, based on the blowing fan unit.

The guide member may include a cabinet suction port disposed at a side of the suction portion to communicate with the suction portion so as to suction air outside the cabinet into the machine room.

The cabinet suction port may be defined by an opening of at least a part of the cabinet mounting portion of the guide member.

Air passing through the cabinet suction port may pass through the deodorizing module.

The guide member may include a cabinet discharge port disposed at a side of the discharge portion to communicate with the discharge portion so as to discharge air inside the machine room to the outside of the cabinet.

The cabinet discharge port may be defined by an opening of at least a part of the cabinet mounting portion of the guide member.

Air passing through the deodorizing module may pass through the cabinet discharge port.

### BRIEF DESCRIPTION OF THE DRAWINGS

FIG. 1 is a perspective view showing a state in which a machine room at the rear of a refrigerator according to an embodiment of the present disclosure is opened.

FIG. 2 is a plan view showing an air flow state of the machine room.

FIG. 3 is a perspective view showing the internal structure of the machine room.

FIG. 4 is an exploded perspective view showing a state in which a guide member and a deodorizing module are separated from the machine room.

FIG. 5 is an enlarged view of portion A of FIG. 3.

FIG. 6 is a perspective view showing the configuration of the guide member and the deodorizing module according to an embodiment of the present disclosure.

FIG. 7 is a perspective view of FIG. 6 when viewed from another direction.

### DETAILED DESCRIPTION OF THE EMBODIMENTS

Hereinafter, some embodiments of the present disclosure will be described in detail with reference to the accompanying drawings. It should be noted that when components in the drawings are designated by reference numerals, the same components have the same reference numerals as far as possible even though the components are illustrated in different drawings. Further, in description of embodiments of the present disclosure, when it is determined that detailed descriptions of well-known configurations or functions disturb understanding of the embodiments of the present disclosure, the detailed descriptions will be omitted.

Also, in the description of the embodiments of the present disclosure, the terms such as first, second, A, B, (a) and (b) may be used. Each of the terms is merely used to distinguish the corresponding component from other components, and does not delimit an essence, an order or a sequence of the corresponding component. It should be understood that when one component is “connected”, “coupled” or “joined” to another component, the former may be directly connected or jointed to the latter or may be “connected”, coupled” or “joined” to the latter with a third component interposed therebetween.

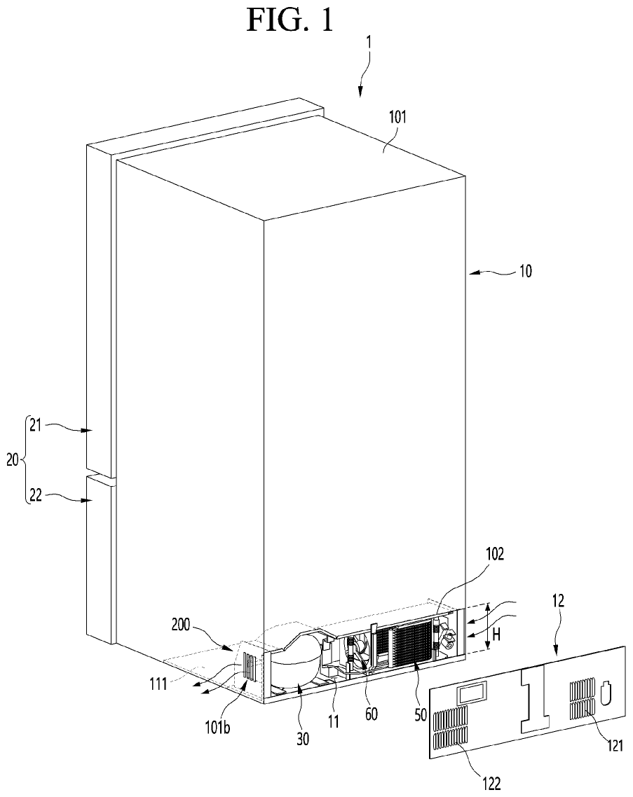

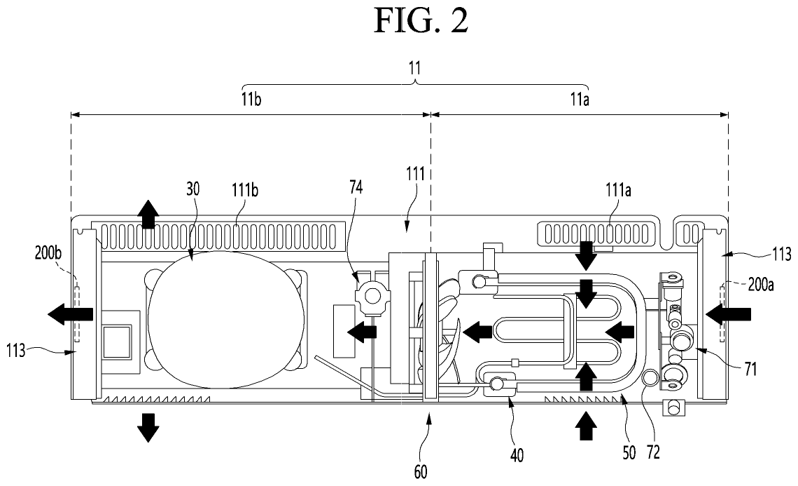

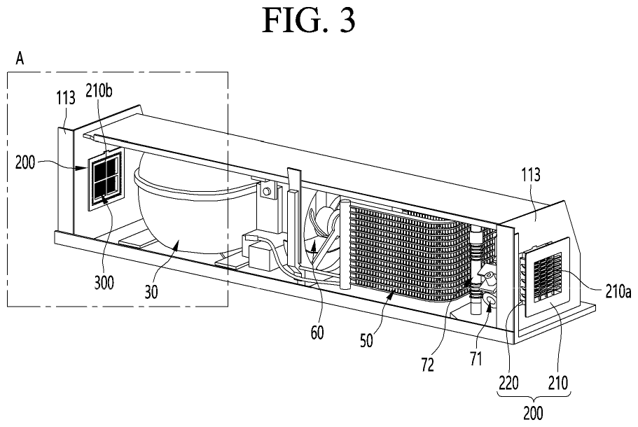

FIG. 1 is a perspective view showing a state in which a machine room at the rear of a refrigerator according to an embodiment of the present disclosure is opened, FIG. 2 is a plan view showing an air flow state of the machine room, and FIG. 3 is a perspective view showing the internal structure of the machine room.

Hereinafter, for convenience of understanding, a direction toward a door 20 to be described below is defined as a front, and a direction toward a machine room cover 12 that shields a machine room opening 102 is defined as a rear.

Referring to FIGS. 1 to 3, a refrigerator 1 according to an embodiment of the present disclosure may include a cabinet 10 defining a storage space and a door 20 opening or closing the storage space.

The storage space may be partitioned vertically or horizontally to define a plurality of spaces, and may be cooled to different temperatures and used as a refrigerating compartment or a freezing compartment.

The door 20 may be configured to open or close the plurality of storage spaces. The door 20 may be rotatably mounted to a cabinet 10, or may be mounted to be slidable in and out, and may open or close the storage spaces independently. In the present embodiment, a case in which the storage space is partitioned vertically and the door 20 also includes an upper door 21 and a lower door 22 will be described as an example.

The cabinet 10 may include an outer case 101 defining an outer appearance and an inner case defining the storage space inside the outer case 101.

A heat insulating material may be filled between the outer case 101 and the inner case to insulate the storage space.

A machine room 11 may be provided at a lower rear end of the cabinet 10. The machine room 11 may define a space in which components constituting a refrigeration cycle for cooling the storage space are disposed, and may be partitioned from the storage space to define an independent space.

The machine room 11 may communicate with an external space so that the components inside the machine room 11 are cooled or heat-exchanged.

A compressor 30 for compressing and supplying a refrigerant at high temperature and high pressure, a condenser 50 for dissipating heat from the high-temperature and high-pressure refrigerant supplied from the compressor 30, a blowing fan unit 60 for forced flow of air inside the machine room 11 may be provided inside the machine room 11.

In an embodiment, a water valve 71 for supplying water to an ice maker or a dispenser provided in the refrigerator 1 may be further provided inside the machine room 11. An expansion device 74 (at least one of an expansion valve, an electromagnetic expansion valve, and a capillary tube) for depressurizing the refrigerant discharged from the condenser 50 may be further provided inside the machine room 11.

The machine room 11 may include a bottom plate 111 defining a bottom surface and side frames 113 provided on left and right sides of the bottom plate 111 to define both side surfaces.

The bottom plate 111 may include the compressor 30, the condenser 50, and the blowing fan unit 60. The compressor 30, the condenser 50, and the blowing fan unit 60 may be directly or indirectly mounted to the bottom plate 111.

The bottom plate 111 may be provided with a base pan 40 on which the condenser 50 is mounted. A drain hose 72 for discharging defrost water, which is generated in the evaporator or a space in which the evaporator is disposed, to the base pan 40 may be provided vertically above the base pan 40.

A plurality of drain hoses 72 may be provided according to the number of evaporators, and may extend from a position corresponding to the position of the evaporator to the upper surface of the base pan 40. The base pan 40 may be referred to as a drain pan because the defrost water discharged by the drain hose 72 is stored.

The condenser 50 and the base pan 40 may be configured to be easily separated and mounted through the machine room opening 102 for service even after the machine room 11 is assembled and mounted to the cabinet 10.

The inside of the machine room 11 may be partitioned left and right based on the blowing fan unit 60. The condenser 50 may be disposed on one side, and the compressor 30 may be disposed on the other side. A region in which the condenser 50 is disposed may be referred to as a suction portion 11a through which outside air is suctioned, and a region in which the compressor 30 is disposed may be referred to as a discharge portion 11b through which outside air is discharged.

The machine room cover 12 may be mounted in the machine room opening 102 defined on the rear surface of the machine room 11. The machine room cover 12 may define the outer appearance of the rear surface of the machine room 11 and a part of the rear surface of the refrigerator 1, and may shield the machine room opening 102 to prevent the components inside the machine room 11 from being exposed to the outside.

The machine room cover 12 may be provided with a cover suction port 121 through which outside air is suctioned and a cover discharge port 122 through which air inside the machine room 11 is discharged to the outside. The cover suction port 121 may be defined at a position corresponding to the condenser 50, and the cover discharge port 122 may be defined at a position corresponding to the compressor 30. The cover suction port 121 and the cover discharge port 122 may be formed in the shape of a grill including a plurality of holes, and may be inclined or rounded so that the suctioned and discharged air has a directionality.

Therefore, when the blowing fan unit 60 is driven, outside air introduced through the cover suction port 121 may cool the condenser 50 while passing through the condenser 50, may be blown toward the compressor 30 to cool the compressor 30, and may be discharged to the outside through the cover discharge port 122.

A plate suction port 111a and a plate discharge port 111b may be defined in the bottom plate 111 defining the bottom surface of the machine room 11. The plate suction port 111a may be defined in the region of the suction portion 11a, and may be horizontally elongated at the front end of the bottom plate 111. The plate discharge port 111b may be defined in the region of the discharge portion 11b, and may be horizontally elongated at the front end of the bottom plate 111.

Therefore, when the blowing fan unit 60 is driven, outside air introduced through the plate suction port 111a may cool the condenser 50 while passing through the suction portion 11a, may be blown toward the discharge portion 11b to cool the compressor 30, and may be discharged to the outside through the plate discharge port 111b or the cover discharge port 122.

A cabinet suction port 210a and a cabinet discharge port 210b may be defined on both side surfaces of the cabinet 10 corresponding to both side surfaces of the machine room 11. Outside air may be suctioned in through the cabinet suction port 210a, and the cabinet suction port 210a may communicate with the suction portion 11a, that is, the region in which the condenser 50 is disposed.

Air inside the machine room 11 may be discharged to the outside through the cabinet discharge port 210b, and the cabinet discharge port 210b may communicate with the discharge portion 11b, that is, the region in which the compressor 30 is disposed.

Therefore, when the blowing fan unit 60 is driven, outside air introduced through the cabinet suction port 210a may cool the condenser 50 while passing through the condenser 50, may be blown toward the compressor 30 to cool the compressor 30, and may be discharged to the outside through one or more of the cabinet discharge port 210b, the plate discharge port 111b, and the cover discharge port 122.

In summary, the inside of the machine room 11 may be divided into the suction portion 11a and the discharge portion 11b on both sides by the blowing fan unit 60 as a whole, so that the suction and discharge of air may be made three-dimensionally.

Outside air may be forcibly suctioned through the front cover suction port 121, the rear plate suction port 111a, and the side cabinet suction port 210a based on the condenser 50, may flow into the suction portion 11a, and may pass through the front and rear side surfaces of the condenser 50 defined along the inner circumference of the plate suction port 111a. That is, outside air passes evenly over the entire surface with respect to the condenser 50, so that effective heat dissipation of the condenser 50 may be achieved.

Air inside the machine room 11 may be discharged to the outside after cooling the compressor 30 through the front cover discharge port 122, the rear plate discharge port 111b, and the side cabinet discharge port 210b based on the compressor 30. That is, air discharged by the blowing fan unit 60 may cool the compressor 30 while passing through the side compressor 30, and may be discharged to the front, rear, and side of the discharge portion 11b.

As such, the condenser 50 dissipates heat while outside air is three-dimensionally supplied to the plate suction port 111a by the operation of the blowing fan unit 60. After three-dimensional cooling the compressor 30, air may be discharged to the outside through the discharge portion 11b.

The refrigerator 1 according to the embodiment of the present disclosure may include a guide member 200 so as to allow air to be introduced into or discharged from the machine room 11.

The guide member 200 may include a first guide member 200a defining the cabinet suction port 210a so that outside air suctioned from the outside of the cabinet 10 flows into the machine room 11, and a second guide member 200b defining the cabinet discharge port 210b so that air inside the machine room 11 is discharged.

One side of the first guide member 200a may be mounted on one side of the cabinet 10 to define a suction passage, and the other side of the first guide member 200a may be mounted to the machine room 11.

The first guide member 200a may have one side mounted to a first cabinet opening 101a defined on one side of the cabinet 10, and the other side mounted to a first frame opening 113a defined in the side frame 113. In this case, the first cabinet opening 101a and the first frame opening 113a may be opened at positions corresponding to each other.

One side of the second guide member 200b may be mounted on one side of the cabinet 10 to define a discharge passage, and the other side of the second guide member 200b may be mounted to the machine room 11.

The second guide member 200b may have one side mounted to a second cabinet opening 101b defined on one side of the cabinet 10, and the other side mounted to a second frame opening 113b defined in the side frame 113. In this case, the second cabinet opening 101b and the second frame opening 113b may be opened at positions corresponding to each other.

Therefore, when the blowing fan unit 60 is driven, outside air introduced through the cabinet suction port 210a cools the condenser 50 while passing through the condenser 50 via the first guide member 200a. Air, which is blown toward the compressor 30 to cool the compressor 30, may pass through the second guide member 200b and may be discharged to the outside through the cabinet discharge port 210b.

As such, when outside air flows into the inside of the machine room 11 by the operation of the blowing fan unit 60, passes through the base pan 40, and is discharged to the outside of the machine room 11, the outside air passes through the defrost water stored in the base pan 40, causing an odor to be generated.

In order to prevent such a problem, the guide member 200 may include a deodorizing module 300 for preventing odor generation.

Hereinafter, the configuration and structure of the guide member 200 and the deodorizing module 300 will be described in more detail with reference to the drawings.

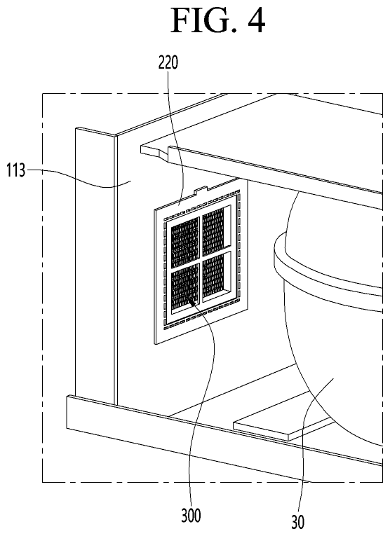

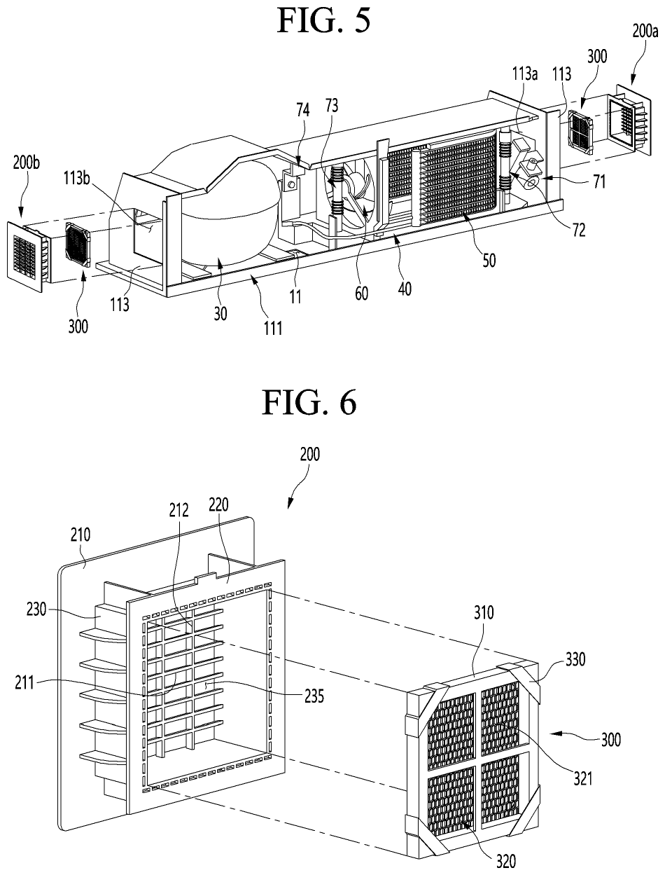

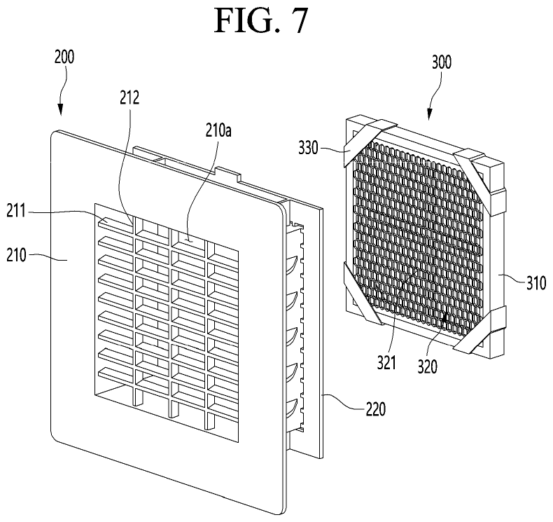

FIG. 4 is an exploded perspective view showing a state in which the guide member and the deodorizing module are separated from the machine room, FIG. 5 is an enlarged view of portion A of FIG. 3, FIG. 6 is a perspective view showing the configuration of the guide member and the deodorizing module according to an embodiment of the present disclosure, and FIG. 7 is a perspective view of FIG. 6 when viewed from another direction.

As described above, the guide member 200 may be provided to allow air to be introduced into or discharged from the machine room 11.

The first guide member 200a is provided at a side of the suction portion 11a, and the second guide member 200b is provided at a side of the discharge portion 11b.

Except for the installation positions of the first guide member 200a and the second guide member 200b, the configuration of the first guide member 200a and the configuration of the second guide member 200b may be the same as each other.

The guide member 200 may include a cabinet mounting portion 210 mounted to the cabinet 10, a machine room mounting portion 220 spaced apart from the cabinet mounting portion 210 and mounted to the machine room 11, and an accommodation portion 235 connecting the cabinet mounting portion 210 to the machine room mounting portion 220 and accommodating the deodorizing module 300 therein.

The cabinet mounting portion 210 may be formed in a rectangular shape, and may be mounted to the cabinet 10. For example, the cabinet mounting portion 210 may be mounted to the cabinet 10 to define a part of the outer appearance of the refrigerator 1.

The cabinet mounting portion 210 may be mounted in cabinet openings 101a and 101b defined on the side surface of the cabinet 10. The cabinet mounting portion 210 of the first guide member 200a may be mounted in the first cabinet opening 101a defined at a side of the suction portion 11a, and the cabinet mounting portion 210 of the second guide member 200b may be mounted in the second cabinet opening 101b defined at a side of the discharge portion 11b.

At least a part of the cabinet mounting portion 210 may be opened to define the cabinet suction port 210a or the cabinet discharge port 210b.

At least a part of the cabinet mounting portion 210 of the first guide member 200a may be opened to define the cabinet suction port 210a, and at least a part of the second guide member 200b may be opened to define the cabinet discharge port 210b.

In an embodiment, at least a part of the cabinet mounting portion 210 may be opened, and a plurality of horizontal ribs 211 and a plurality of vertical ribs 212 crossing each other at set intervals may be provided in the opening.

The cabinet suction port 210a or the cabinet discharge port 210b may be defined in a space between the plurality of horizontal ribs 211 and the plurality of vertical ribs 212 crossing each other. The plurality of horizontal ribs 211 and the plurality of vertical ribs 212 may have an inclination, and may be inclined so that inflow or outflow air has a directionality.

The machine room mounting portion 220 may be spaced apart from the cabinet mounting portion 210 and mounted to the machine room 11. For example, the machine room mounting portion 220 may be mounted to the side frame 113.

The machine room mounting portion 220 may be mounted in the frame openings 113a and 113b defined in the side frame 113. The machine room mounting portion 220 of the first guide member 200a may be mounted in the first frame opening 113a defined at a side of the suction portion. The machine room mounting portion 220 of the second guide member 200b may be mounted in the second frame opening 113b defined at a side of the discharge portion 11b.

In a state in which the first cabinet opening 101a and the first frame opening 113a are defined at positions corresponding to each other, and thus the cabinet mounting portion 210 of the first guide member 200a is mounted to the first cabinet opening 101a, the machine room mounting portion 220 of the first guide member 200a may be mounted to the first frame opening 113a. In a state in which the second cabinet opening 101b and the first frame openings 113a and 113b are defined at positions corresponding to each other, and thus the cabinet mounting portion 210 of the second guide member 200b is mounted to the second cabinet opening 101b, the machine room mounting portion 220 of the second guide member 200b may be mounted to the second frame opening 113b.

At least a part of the machine room mounting portion 220 may be opened to communicate with the cabinet suction port 210a or the cabinet discharge port 210b.

The connection portion 230 may connect the cabinet mounting portion 210 to the machine room mounting portion 220 and define an accommodation portion 235 in which the deodorizing module 300 is accommodated.

For example, the connection portion 230 may be formed in a rectangular frame shape. A plurality of ribs may be defined on the outer surface of the connection portion 230 to support the cabinet mounting portion 210.

Through the connection portion 230, outside air suctioned from the outside of the cabinet 10 may flow into the machine room 11 without loss, and may be discharged to the outside of the cabinet 10 without loss of air inside the machine room 11.

In detail, air suctioned from the outside of the cabinet 10 through the cabinet suction port 210a flows into the machine room 11 through the connection portion 230 of the first guide member 200a. Air flowing into the machine room 11 may be discharged to the cabinet discharge port 210b through the connection portion 230 of the second guide member 200b. That is, the connection portion 230 defines a passage through which air passes.

Air passing through the machine room 11 as described above passes through the defrost water stored in the base pan 40, causing an odor to be generated.

In order to prevent such a problem, the deodorizing module 300 may be provided in the connection portion 230.

The deodorizing module 300 may be inserted into the opened machine room mounting portion 220 and accommodated in the accommodation portion 235. For example, the deodorizing module 300 may be formed in a size corresponding to the size of the accommodation portion 235 and mounted to the accommodation portion 235. For example, when the connection portion 230 is formed in a shape of a square frame, the deodorizing module 300 may be formed in a rectangular parallelepiped shape corresponding to the size of the accommodation portion 235.

In an embodiment, the deodorizing module 300 may include a deodorizing filter 320.

The deodorizing filter 320 may remove odorous substances contained in air passing through the deodorizing module 300. In detail, the deodorizing filter 320 may remove an odor by adsorbing odorous substances in air passing through the deodorizing module 300.

In an embodiment, the deodorizing filter 320 may be configured to include a material capable of adsorbing and removing odorous substances contained cold air, and may include, for example, activated carbon, carbon fiber, silica, zeolite, and the like. In particular, the activated carbon is a carbon aggregate in which countless pores are formed and may easily adsorb odorous substances.

The deodorizing filter 320 may include a plurality of through-holes 321 penetrating in the horizontal direction. A plurality of through-holes 321 may be spaced apart from each other to penetrate from one surface to the other surface of the deodorizing filter 320. Cold air may smoothly flow into the deodorizing filter 320 through the through-holes 321.

In an embodiment, the deodorizing module 300 may further include a frame (or a module frame) 310 supporting the deodorizing filter 320.

The frame 310 may define the outer shape of the deodorizing module 300. For example, when the connection portion 230 is formed in a shape of a rectangular frame, the frame 310 may be formed in a rectangular parallelepiped shape corresponding to the size of the accommodation portion 235.

The frame 310 may be formed, for example, in a shape surrounding the outer circumference of the deodorizing filter 320. The deodorizing filter 320 may be formed singly or in plurality and mounted to the frame 310.

The deodorizing module 300 may further include a fixing portion 330 protruding from the frame 310 so as to be stably fixed to the accommodation portion 235. The fixing portion 330 may be integrally formed with the frame 310. Alternatively, the fixing portion 330 may be attached to the frame 310. For example, the fixing portion 330 may be a foam PE attached to the frame 310.

When the blowing fan unit 60 is driven, air outside the cabinet 10 is suctioned into the machine room 11 through the cabinet suction port 210a. In this case, due to the accommodation portion 235, air suctioned into the machine room 11 from the cabinet suction port 210a may not be lost. Air suctioned into the machine room 11 cools the condenser 50 and the compressor 30. In this case, air may contain odorous substances due to the defrost water that is stagnated in the base pan 40. However, the odor is removed through the deodorizing module 300 accommodated in the accommodation portion 235, and then, the air may be discharged to the outside of the cabinet 10 through the cabinet discharge port 210b.

According to the embodiment of the present disclosure, it is possible to remove an odor from air flowing in and out for the cooling of the components of the machine room. In particular, it is possible to remove an odor from air by providing the deodorizing module in a passage through which air flows for the cooling of the components of the machine room.

The above description is merely illustrative of the technical idea of the present disclosure, and various modifications and changes may be made thereto by those skilled in the art without departing from the essential characteristics of the present disclosure.

Therefore, the embodiments of the present disclosure are not intended to limit the technical spirit of the present disclosure but to describe the technical idea of the present disclosure, and the technical spirit of the present disclosure is not limited by these embodiments.

The scope of protection of the present disclosure should be interpreted by the appending claims, and all technical ideas within the scope of equivalents should be construed as falling within the scope of the present disclosure.

What is claimed is:

1. A refrigerator comprising:
a cabinet defining a storage space and a machine room that is partitioned from the storage space, the machine room including a compressor and a condenser;
a blowing fan provided in the machine room;
a guide member configured to guide air from an outside of the machine room into the machine room and discharge air from the machine room to the outside of the machine room; and
a deodorizing module that is provided inside the guide member and that is configured to remove an odor from air passing through the guide member.

2. The refrigerator of claim 1, wherein the guide member has a first side mounted to the cabinet and a second side mounted to the machine room.

3. The refrigerator of claim 2, wherein the guide member comprises:
a cabinet mounting portion mounted to the cabinet,
a machine room mounting portion that is spaced apart from the cabinet mounting portion and that is mounted to a frame of the machine room, and
a connection portion that connects the cabinet mounting portion to the machine room mounting portion and that defines an accommodation portion in which the deodorizing module is accommodated.

4. The refrigerator of claim 3, wherein the connection portion defines a passage through which air flows.

5. The refrigerator of claim 3, wherein a size of the deodorizing module corresponds to a size of the accommodation portion.

6. The refrigerator of claim 3, wherein the deodorizing module comprises a deodorizing filter configured to remove an odor by adsorbing odorous substances in the air.

7. The refrigerator of claim 6, wherein the deodorizing module further comprises a module frame that supports the deodorizing filter and that defines an outer shape of the deodorizing module.

8. The refrigerator of claim 7, wherein the deodorizing module further comprises a fixing portion that protrudes from the module frame and that couples to the accommodation portion.

9. The refrigerator of claim 3, wherein the blowing fan is provided between the compressor and the condenser and divides the machine room into a suction portion in which the condenser is disposed and a discharge portion in which the compressor is disposed.

10. The refrigerator of claim 9, wherein the guide member comprises a cabinet suction port that is disposed at a side of the suction portion and that is in fluid communication with the suction portion so as to suction air outside the cabinet into the machine room.

11. The refrigerator of claim 10, wherein an opening of a part of the cabinet mounting portion of the guide member defines the cabinet suction port.

12. The refrigerator of claim 10, wherein air passing through the cabinet suction port passes through the deodorizing module.

13. The refrigerator of claim 9, wherein the guide member comprises a cabinet discharge port that is disposed at a side of the discharge portion and that is in fluid communication with the discharge portion so as to discharge air inside the machine room to the outside of the cabinet.

14. The refrigerator of claim 13, wherein an opening of a part of the cabinet mounting portion of the guide member defines the cabinet discharge port.

15. The refrigerator of claim 13, wherein air passing through the deodorizing module passes through the cabinet discharge port.

16. The refrigerator of claim 1, wherein the guide member includes a first guide member defining a cabinet suction port through which the air from the outside of the machine room passes through to enter the machine room and a second guide member defining a cabinet discharge port through which air from the machine room is discharged to the outside of the machine room.

17. The refrigerator of claim 16, wherein the first guide member has a first side that is mounted to a first side of the cabinet and that defines a suction passage and a second side that is mounted to the machine room.

18. The refrigerator of claim 16, wherein the first guide member has a first side that is mounted to a first cabinet opening defined at the cabinet and a second side that is mounted to a first frame opening defined at a side frame of the machine room, and
wherein a position of the first cabinet opening and a position of the first frame opening correspond to each other.

19. The refrigerator of claim 16, wherein the second guide member has a first side that is mounted to a first side of the cabinet and that defines a discharge passage and a second side that is mounted to the machine room.

20. The refrigerator of claim 16, wherein the second guide member has a first side that is mounted to a second cabinet opening defined at the cabinet and a second side that is mounted to a second frame opening defined at a side frame of the machine room, and
wherein a position of the second cabinet opening and a position of the second frame opening correspond to each other.
